(19) United States
(12) Patent Application Publication
(10) Pub. No.: US 2026/0210793 A1
(43) Pub. Date: Jul. 23, 2026

(54) High Pressure Gas Fitting Leak Detection Systems and Related Methods

(71) Applicant: HP Leak Detection LLC, Prescott, AZ (US)

(72) Inventor: Dale Aurich, Prescott, AZ (US)

(73) Assignee: HP Leak Detection LLC, Prescott, AZ (US)

(21) Appl. No.: 19/570,030

(22) Filed: Mar. 17, 2026

Related U.S. Application Data
(63) Continuation-in-part of application No. 19/090,215, filed on Mar. 25, 2025, now Pat. No. 12,578,246.
Application No. 19/090,215 is a continuation of application No. 18/482,477, filed on Oct. 6, 2023, now Pat. No. 12,276,578.

(51) Int. Cl. G01M 3/28; F16L 23/04; F16L 23/16

(52) U.S. Cl. CPC G01M 3/2853; F16L 23/04; F16L 23/167; F16L 2201/30

(57) ABSTRACT

Implementations of a gas leak indication system may include a plurality of indicator systems coupled with a communication wire, and a ring included in each indicator system of the plurality of indicator systems, the ring configured to be coupled between two hubs of a clamp connector of a plurality of clamp connectors included in a gas pipeline. The communication wire may be operably coupled with a gas leak monitoring system.

### CROSS REFERENCE TO RELATED APPLICATIONS

This application is a continuation-in-part application of the earlier U.S. Utility Patent Application to Aurich entitled “High Pressure Gas Fitting Leak Detection Systems and Related Methods,” application Ser. No. 19/090,215, filed Mar. 25, 2025, now pending, which application is a continuation application of the earlier U.S. Utility Patent Application to Aurich entitled “High Pressure Gas Fitting Leak Detection Systems and Related Methods,” application Ser. No. 18/482,477, filed Oct. 6, 2023, now issued as U.S. Pat. No. 12,276,578, the disclosure of which is hereby incorporated entirely herein by reference.

### BACKGROUND

### 1. Technical Field

Aspects of this document relate generally to systems used for high pressure gas distributions systems. More specific implementations involve leak detection systems.

### 2. Background

Gas distribution system transport a wide variety of gas types from supplies to points of consumption. Gas distribution systems are used in various locations including where gas turbine generators and gas turbines are used.

### SUMMARY

Implementations of gas leak indication system may include one, all, or any of the following: the system may include a cap coupled over an indicator coupled to a ring configured to rest against exterior surfaces of a clamp connector. The cap may include a magnetic sensor in magnetic communication with a permanent magnet coupled to the indicator and a controller coupled to the magnetic sensor and configured to process a signal from the magnetic sensor, prepare a corresponding data transmission, and send the data transmission to one of a communication wire or one or more radios operably coupled with the controller. The system may include a power supply operatively coupled with the controller and the magnetic sensor. The system may include a ring including a flange extending from an interior surface of the ring, the ring including a flow opening, and the ring configured to rest against exterior surfaces of a clamp connector; and an indicator coupled to the ring, the indicator including a flow channel extending therethrough in fluid communication with the flow opening of the ring.

Implementations of an indicator system for a gas leak indication system may include one, all, or any of the following:

The system may include an antenna coupled to the one or more radios.

The ring may include a flange configured to rest between two hubs of the clamp connector adjacent to a sealring held between the two hubs and the ring may be configured to be held against the exterior surfaces of the two hubs through a clamp coupled with the two hubs.

The one or more radios may transmit the data transmission to a gas leak monitoring system.

The system may include a solar energy collector operably coupled with the power supply.

The power supply further may include a battery.

When a predetermined flow of gas passes through the flow opening of the ring into the flow channel of the indicator, the cap may be configured to activate the magnetic sensor.

The magnetic sensor may be coupled directly to the cap and the permanent magnet may be coupled directly to the indicator.

The magnetic sensor may be coupled directly to the indicator and the permanent magnet may be coupled directly to the cap.

Implementations of a gas leak indication system may include a plurality of indicator systems coupled with a communication wire, and a ring included in each indicator system of the plurality of indicator systems, the ring configured to be coupled between two hubs of a clamp connector of a plurality of clamp connectors included in a gas pipeline. The communication wire may be operably coupled with a gas leak monitoring system.

Implementations of a gas leak indication system may include one, all, or any of the following:

Each indicator system of the plurality of indicator systems may include a cap coupled over an indicator, a magnetic sensor magnetically coupled with a permanent magnet coupled to the indicator, and a controller operably coupled with the magnetic sensor and with the communication wire where the controller may be further configured to process a signal from the magnetic sensor, prepare a corresponding data transmission, and send the data transmission to the a communication wire.

The ring of each indicator system of the plurality of indicator systems may include a flange extending from an interior surface of the ring, the flange configured to extend between two hubs of a clamp connector, the ring including a flow opening therein and the ring configured to contact exterior surfaces of the hubs of the clamp connector. The cap may be in fluid communication with the flow opening.

When a predetermined flow of gas passes through a flow opening of the ring into a flow channel of the indicator, the cap may be configured to activate the magnetic sensor.

The magnetic sensor may be coupled directly to the cap and the permanent magnet may be coupled directly to the indicator.

The magnetic sensor may be coupled directly to the indicator and the permanent magnet may be coupled directly to the cap.

The communication wire may be configured to supply electric power to the controller and the magnetic sensor.

Implementations of a gas leak indication system may include a ring including a flange extending from an interior surface of the ring, the ring including a flow opening, the ring including a plurality of projections extending from a surface of the ring configured to engage with interior surfaces of hubs of a clamp connector. The system may include an indicator coupled to the ring, the indicator configured to continuously monitor for a leak from the clamp connector while gas flows through the clamp connector. The indicator may be coupled into the flow opening, where the flow opening may be configured to orient the indicator substantially perpendicular to the clamp connector.

Implementations of a gas leak indication system may include one, all, or any of the following:

When a predetermined flow of gas passes through the flow opening of the ring into a flow channel of the indicator, a cap of the indicator may be configured to slidably disengage from the flow opening of the ring.

The plurality of projections resiliently engage with the interior surfaces of the hubs to form a gas-tight seal around a sealring of the clamp connector.

The ring may be included of one of a polymer material or a resin material.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a perspective view of the various components of a gas leak indication system including a ring, an extender, an indicator, and a cap along with two o-rings;

FIG. 2 is a perspective view of an implementation of a ring;

FIG. 3 is a front view of an implementation of a ring;

FIG. 4 is a perspective view of an implementation of a cap;

FIG. 5 is a cross sectional view of an implementation of a cap;

FIG. 6 is a detail cross section view of the cap implementation of FIG. 5;

FIG. 7 is a side view of an implementation of an extender;

FIG. 8 is a perspective view of an implementation of an indicator;

FIG. 9 is a detail view of the flange illustrated in indicator implementation of FIG. 10;

FIG. 10 is a side view of an indicator implementation;

FIG. 11 is a detail view of the groove of the indicator implementation of FIG. 10;

FIG. 12 is a perspective view of an implementation of a hub with a sealring coupled therein with a clamp surrounding the hub;

FIG. 13 is a perspective view of the hub implementation of FIG. 12 with a ring implementation installed;

FIG. 14 is a cross sectional view of an assembled clamp connector showing the flow of gas from a leak;

FIG. 15 is an exploded view of an implementation of a gas leak detection system in conjunction with hubs of a clamp connector;

FIG. 16 is an exploded cross sectional view of another ring implementation adjacent to a hub and sealring;

FIG. 17 is a perspective view of the ring implementation of FIG. 16;

FIG. 18 is a cross sectional view of an assembled clamp connector showing the flow of gas from a leak;

FIG. 19 is a diagram of a pipeline with a plurality of leak detection systems coupled thereto;

FIG. 20 is a diagram of a vise/press during crimping of a cap implementation;

FIG. 21 is a perspective view of a cap showing crimped portions therein;

FIG. 22 is a side cross sectional view of the cap of FIG. 21;

FIG. 23 is an exploded cross sectional view of another ring implementation adjacent to a hub and sealring; and

FIG. 24 is an exploded cross sectional view of another injection molded ring implementation adjacent to a hub and sealring.

### DESCRIPTION

This disclosure, its aspects and implementations, are not limited to the specific components, assembly procedures or method elements disclosed herein. Many additional components, assembly procedures and/or method elements known in the art consistent with the intended gas leak detection system will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such gas leak detection systems, and implementing components and methods, consistent with the intended operation and methods.

A clamp connector is used in high pressure gas systems and includes two hubs with flat faces are joined with a sealring. A clamp is then placed over the edges of the two hubs and bolted down around them, forcing the faces of the hubs closer together and against the sealring. The material of the sealring extends into the remaining gap between the faces of the two hubs. One of the challenges of clamp connector systems is that since the flat faces of the hubs never directly contact one another when clamped, getting the faces of the hubs to be parallel or substantially parallel can require the installer to have to hit the hubs during tightening to approximately align them. If the alignment is not ideal, gas leaks from around the sealring/hub interface can occur. Because the clamp covers the entire interface of the two hubs, it is difficult to detect gas leaks from clamp connectors. FIG. 12 illustrates an implementation of a hub 88 with an implementation of a sealring 90 along with an implementation of a clamp illustrated in a disconnected position adjacent to the hub 88.

Referring to FIG. 15, an exploded view of an implementation of a gas leak detection system 2 for use with clamp connectors is illustrated. In this view, the components of a corresponding clamp connector are illustrated in the form of hubs 4 and 6. The face 7 of hub 6 is also illustrated against which an o-ring placed in a seal channel is resting (not visible in FIG. 15). Seal channel 8 on the other side of flange 10 is visible in FIG. 15 and is sized to receive o-ring 12 which is designed to rest against the face of hub 4 when hub 4 is placed against the flange 10. Projection 14 extends from the exterior surface 18 of ring 16. As illustrated, the flange 10 extends inwardly from an interior surface 20 of the ring 16.

As illustrated, projection 14 includes a flow opening 22 into which extender 24 is designed to threadedly couple. The extender 24 includes a flow opening 26 that extends all the way through the extender 24. Indicator 28 is threadedly coupled with the extender 24 and includes a flow channel 30 that extends all the way through the indicator 28. Cap 32 couples over the indicator 28 down to flange 34 that extends from outer surface 36 of the indicator 28. The cap 32 is held over the indicator 28 at the flange 34 via a friction fit using structures that will be described in more detail herein.

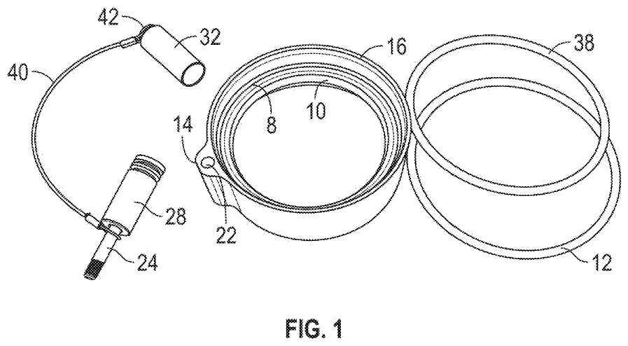

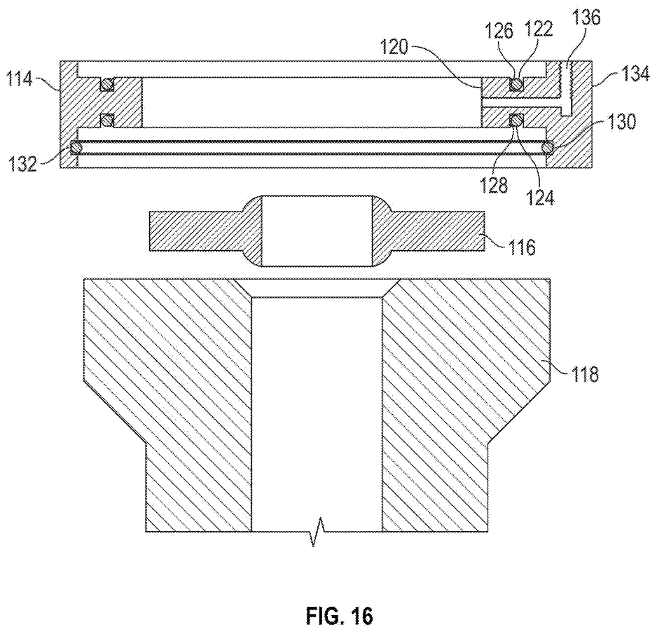

Referring to FIG. 1, the various components of the gas leak indication system 2 are illustrated in a disassembled position over/between hubs 4 and 6. In this position, the exterior surface of the ring 16 is visible, along with the extender 24, indicator 28, and cap 32. While not visible in the black and white views of the figures in this application, the indicator 28 is colored with a color designed to contrast with the metal coloring of the ring and hubs to allow its exposure to become immediately apparent to someone viewing the gas leak indication system 2. In particular implementations, the indicator is colored red using an anodizing process. However, in other implementations, the indicator may be colored using, by non-limiting example, a painting process, a powder coating process, a flame spray process, an etching process, or through use of a metal alloy that has a naturally weathered finish of a particular color. As illustrated in FIG. 16, the cap 32 is dimensioned to cover the indicator 28.

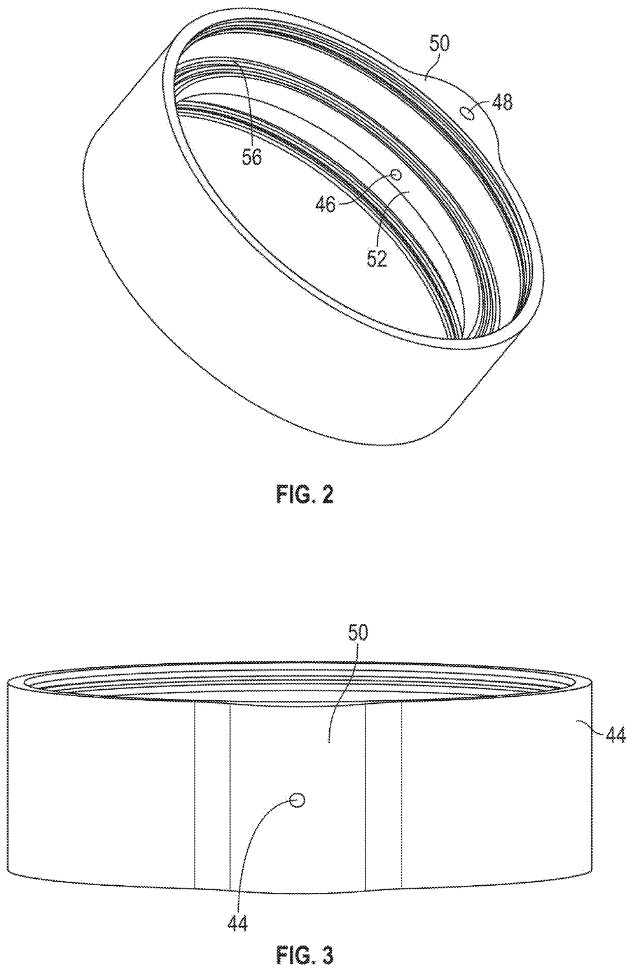

Referring to FIG. 1, the ring 16, o-ring 12, and o-ring 38 are illustrated in an un-assembled position. Here the flange 10 of the ring 16 is visible which includes seal channel 8. The flow opening 22 of the projection 14 is also illustrated next to the assembled extender 24, indicator 28, and cap 32. In FIGS. 1 and 2, a cable 40 is attached around the extender 24 and around the circular projection 42 of the cap 32 to ensure that the cap 32 does not become lost when it releases from the indicator 28. While the use of cable 40 is illustrated in FIGS. 1 and 2, a wide variety of other systems and methods of retaining the cap 32 to the system could be employed, including, by non-limiting example, rope, thread, chain, or any other system of ensuring the cap does not physically separate from the system. In various implementations, the cable 40 may be coiled or curled to enable it to absorb more energy and prevent breakage of the cable in the event of a sudden leak occurring and corresponding loss of the cap.

Referring to FIG. 2, an implementation of a ring 44 is illustrated in a perspective view. Here, the location of flow opening 46 is illustrated, showing that the flow opening 48 of the projection 50 begins on the flange 52 of the ring 44. The seal channel 56 is also illustrated in the flange 52 showing the groove in which the o-rings rest. FIG. 3 is a front view of the ring 44 that shows where the flow opening 46 extends out of the projection 50 which is created during manufacturing of the flow opening 46. Prior to use, the open portion of the flow opening 46 is closed off using a screw, brad, or rivet (not shown in this view).

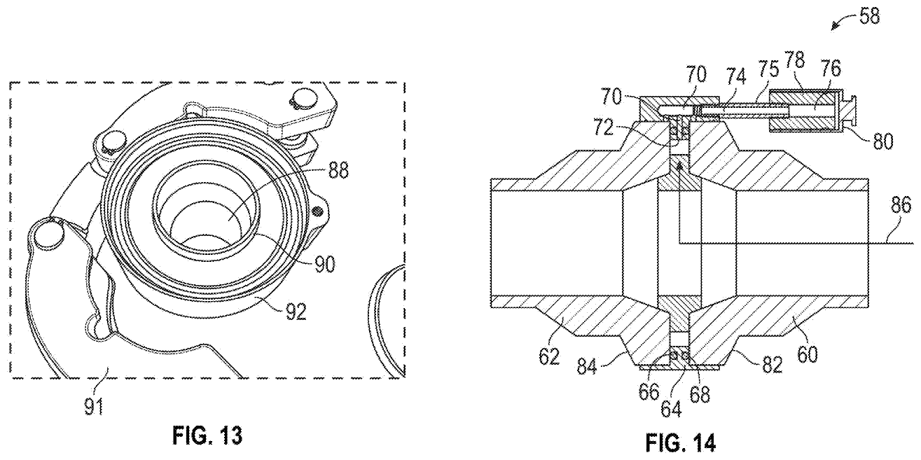

Referring to FIG. 13, the implementation of the hub 88 of FIG. 12 is illustrated with sealring 90 and clamp 91 with ring 94 installed over the hub 88. As illustrated, the projection 96 of the ring 94 is located where the two portions of the clamp 91 are bolted together, which leaves sufficient space for the projection and for the extender to extend beyond the clamp 92 at right angles to the clamp 91. In the various ring implementations disclosed herein, the dimensions of the ring (thickness, flange thickness, o-ring diameter, etc.) are determined by the available space between the clamp and the two hubs of the clamp connector. Accordingly, for smaller clamp connectors, the ring thickness, for example, is thinner while for larger clamp connectors, the ring thickness can be thicker as the tolerance between the hubs and the clamp is correspondingly larger.

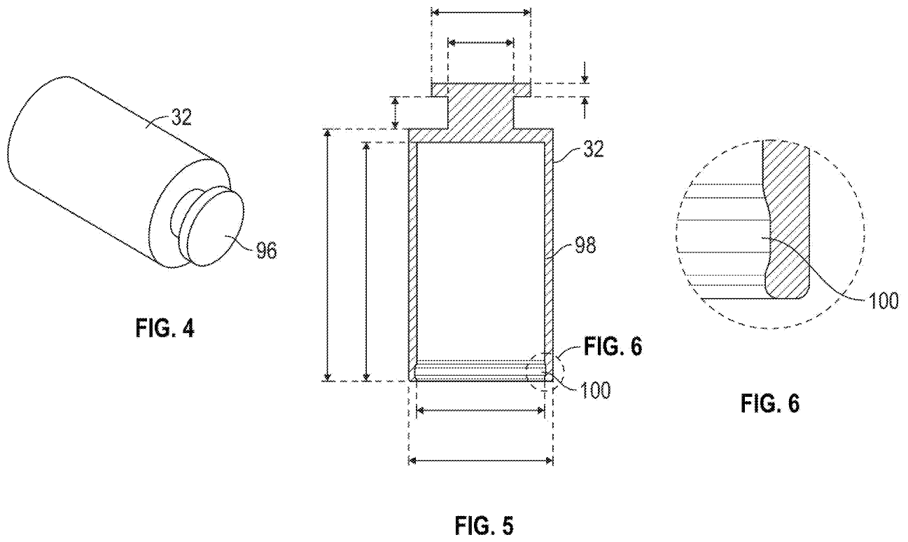

An implementation of the previously described cap is illustrated in more detail in FIGS. 4-6. FIG. 4 illustrates a perspective view of the cap 32 that shows the projection 96 that used to help retain the cap 32 with the gas leak indication system in combination with a cable or other retainer. FIG. 5 is a cross sectional view of the cap 32 that shows how the cap has a constant diameter that corresponds with the diameter of the indicator 28 down to a point along the interior surface 98 of the cap 32 where groove 100 is located that extends around the circumference of the interior surface 98. FIG. 6 is a detail view of the shape of the groove 100, and shows how, in this implementation, the groove is formed of angled and flat surfaces rather than rounded surfaces to aid in forming a friction fit with the flange 112 of FIG. 9 designed to yield at a particular pressure of gas. In other implementations, however, the groove may be formed with rounded surfaces to achieve the desired friction fit. In various implementations, the cap may yield at a pressure of about 2 to about 5 psi, though higher or lower yielding pressures may be used in various implementations.

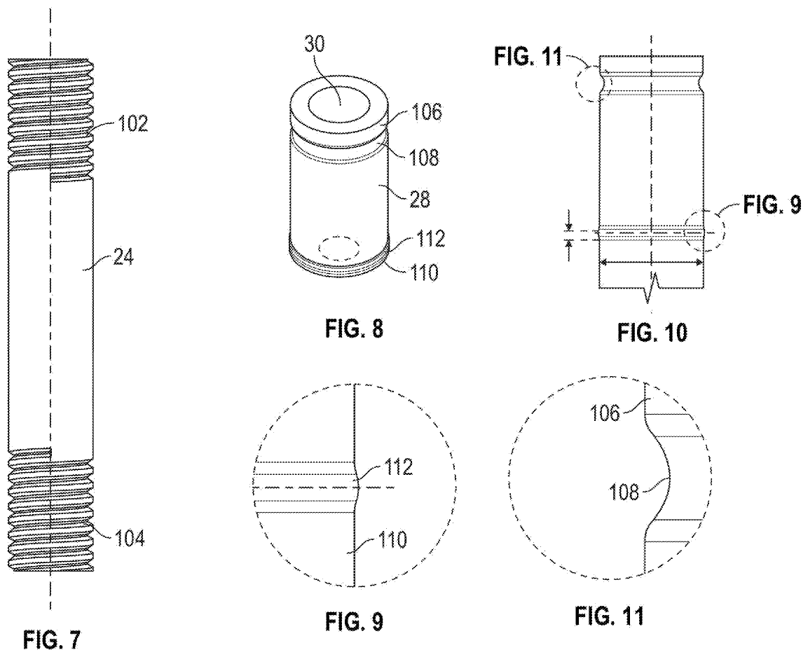

FIG. 7 illustrates a side view of an implementation of an extender 24 showing threaded ends 102, 104. These threaded ends 102, 104 help form gas-tight connections with the flow opening 22 of the projection 14 and with the indicator 28. FIGS. 9-12 are various views of an implementation of indicator 28. FIG. 8 shows the indicator 28 in perspective view with first end 106 with groove 108 extending around the circumference of the indicator 28. In various system and method implementations, the groove 108 is used to retain an end of a balloon thereto during testing for low pressure leaks. Indicator 28 also includes a second end 110 that includes flange 112 that extends around the circumference of the indicator 28. FIG. 10 illustrates the indicator 28 in a closer side view. FIG. 9 illustrates a detail view of the flange 112 showing how the flange has a rounded profile/cross section, which, because it protrudes, engages with each recess of the groove 100 of the cap 32. This rounded profile/cross section of the flange 112 in combination with the flat surfaces of the groove 100 of the cap 32 helps create the friction fit that is designed to yield at the desired/predetermined gas pressure.

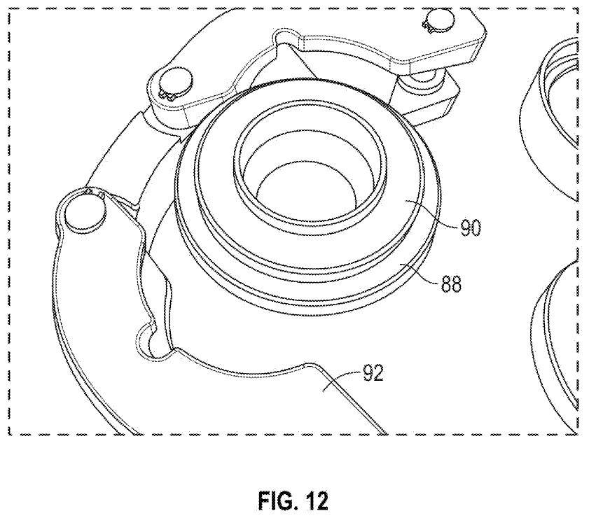

Referring to FIG. 11, the first end 106 of the indicator 28 includes the groove 108. The groove 108 is sized and profiled to retain a balloon, particularly the rounded rubber ring end of a balloon, which is used in place of the cap during low pressure leak monitoring as will be described hereafter.

While the use of a groove/flange combination to hold the cap over the indicator to a desired pressure is illustrated in this document, other mechanical configurations/systems may be used. For example, an o-ring may replace the flange in the indicator and engage in the corresponding flange in the cap to provide the desired friction fit that yields at the desired leak pressure. In such an implementation, the indicator would then have two grooves therein, one for the o-ring and the other for holding a balloon for low pressure testing. In some implementations, however, the groove for the balloon testing may not be used and only the groove for the o-ring may be employed. Similarly, in some indicator implementations, only the flange for retaining the cap may be included and the groove for the balloon testing may be omitted.

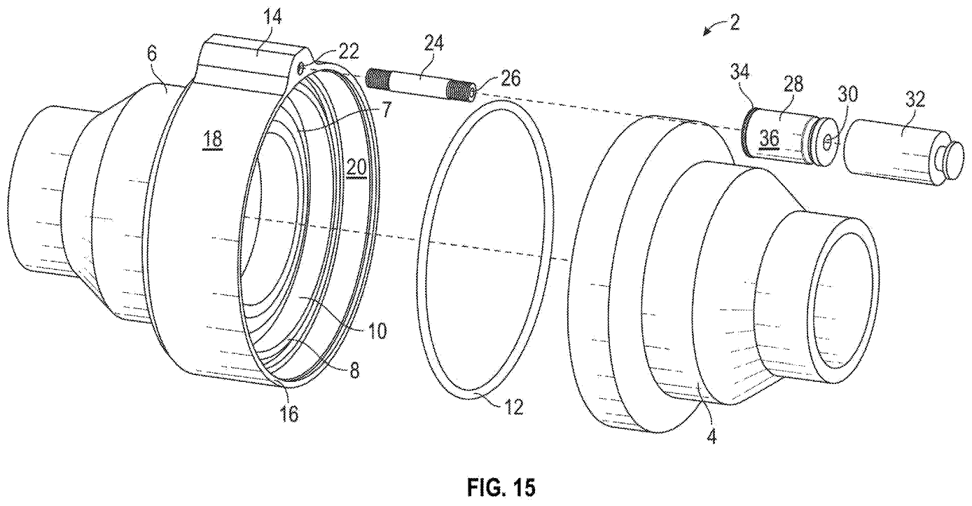

Referring to FIG. 14, a cross sectional diagram of an implementation of a gas leak indication system 58 is illustrated during operation when installed in a clamp connector system. In this view, the clamp itself is omitted for purposes of easier illustration. As illustrated, the two hubs 60, 62 of the clamp connector system are illustrated in position with the sealring that would normally in place spacing the two hubs 60, 62 apart removed for ease of illustration of the gas flow. As illustrated, the ring 64 has been installed into the space between the two hubs 60, 62 created by the seal ring and o-rings 66, 68 are illustrated contacting the faces of the two hubs 60, 62, sealing the outer perimeter of the two hubs 60, 62 to gas flow. Flow opening 70 through flange 72 of the ring 64 is illustrated which is in fluid connection with the flow opening 74 of the extender 75. The flow opening 74 is also in fluid connection with the flow channel 76 of the indicator 78 over which cap 80 is currently coupled and held in place with a friction fit.

During operation, the two hubs 60, 62 are held together using a bolted clamp that has two flanges, one of which rests on the outer shoulder 82 of hub 60 and the other flange rests on the outer shoulder 84 of hub 62. Since the outer shoulders 82, 84 are slanted, the circumferential inward pressure exerted by the flanges of the bolted clamp (an example of which is illustrated in FIG. 13) press the faces of the hubs 60, 62 against the sealring with the goal of establishing a gas-tight fitting. As illustrated in FIG. 14, the flange 72 and o-rings 66, 68 are sized for each hub size used in clamp connectors and also sized to not interfere with sealring function when mating with hubs to create a gas-tight seal around the circumference of each hub 60, 62. This insertion of the flange into the space between the hubs has the benefit of providing an additional mechanical support/space at the edges of the hubs 60, 62 and maintain parallelism at the faces of the hubs 60, 62.

The gas leak indication system 58 previously described can be used in various implementations of a method of detecting a gas leak in a clamp connector. Referring to FIG. 14, as indicated by the gas flow arrow 86, any leaking gas from around the sealring flows into the space between edge of the sealring and the flange 72. Because of the seal provided by the flange around the hubs 60, 62, the only place for the gas 86 to escape this space is through the flow opening 70 in the flange 72 and up through the flow opening 74 of the extender 75 and into the flow channel 76 of the indicator 78. The leaking gas 86 then builds up pressure against the interior surface of the cap 80 since the tolerance of the cap 80 around the indicator 78 and/or the friction fit tolerance of the flange (not illustrated in FIG. 14) holding the cap 80 on the indicator 78 is sufficiently small to allow little to no gas flow able to relieve pressure build up from a leak. As a result, the pressure built up against the cap 80 causes the cap to disengage from the indicator 78 and pop off, exposing the entire outer surface of the indicator 78. Collectively, the extender 75, the indicator 78, and the cap 80 form a flow detection system in fluid communication with the flow opening 70 of the ring 64.

Now that the entire outer surface of the indicator 78 has been exposed, a technician or other maintenance worker can immediately see that a gas leak is occurring at this specific clamp connector in the system. As clamp connectors themselves do not come with any type of gas leak detection, in the past, when a gas leak was suspected either through gas monitors (as in the case of natural gas) or through abnormal gas consumption, the technicians would have to enter the facility and perform testing while in a potentially dangerous environment created by the leaking gas. During this process, each fitting would be leak tested separately with sniffers or a rag on a stick to attempt to locate the clamp connectors that were leaking. Because it can take a full day or more find a leak, immediate detection could significantly reduce downtime and increase operational safety. Furthermore, because of the seal provided by the flange of the ring, the maximum amount of gas that can leak to atmosphere is controlled by the size of the flow opening 70 in the flange 72. This ability to meter the quantity of gas leaking can reduce the likelihood of catastrophic or serious leaks when the gas leak indication systems is used for any clamp connector system. This ability to stabilize and control leaks may permit correction of the leak during a scheduled maintenance period rather than requiring immediate shutdown of a facility to avoid a hazardous condition.

In various method implementations, particularly during startup or initial testing of a clamp connector, the present gas leak indication systems can be used to detect leaks prior to full pressurization of the clamp connector. In such method implementations, instead of use of a flow detection system that includes the cap, indicator, and extender, a flow detection system that replaces the cap with a balloon is used. In such method implementations, a hand vacuum pump is used to draw a rubber balloon into the flow channel of the indicator prior to installation of the indicator and extender. The process of pressurizing the line in which the clamp connector is then begun. Since a balloon can begin to inflate at about 1/10^{th} psi, leaks below the threshold detection of the cap system (in some implementations, about 5 psi or higher) can be detected by a technician/operator observing the balloon beginning to inflate from the interior of the indicator, providing a clear visual signal that a leak is present. As the balloon enables detection of leaks as they are forming at a low pressure operational stage, this method implementation can allow for detection prior to having to reach full pressurization. For systems where it can take up to a day to bring the line up to full pressure, this ability to detect the leak in the clamp connector during pressurization can be very valuable and help greatly with evaluating repairs and new installations to ensure that delivery of the system or handover to operations can be completed on time or even ahead of schedule.

The various system and method implementations disclosed herein also have the ability to help with installation of the clamp connectors independent of their gas leak detection effects. Because the flange of the ring is inserted between the two hubs and dimensioned in combination with the o-rings to match a desired separation of the two hubs around the edges of the hubs, during tightening of the clamp, the flange of the ring can help ensure that the two hubs retain the desired spacing and parallelism. While the sealring is not designed to do this, the profile of the sealring's contact surface is radiused, making it difficult to maintain a parallel sealing surface during tightening causing one side of the hubs to have a wider or thinner separation than the other side. The ability to maintain a parallel spacing between the faces of the hubs around the joint provides a more uniform fit of the sealring to the flange and can ensure that a desired/design separation between the two hubs exists. The use of the ring and flange as part of the clamp connector creates a self-aligning effect that helps remove a source of potential leaks and misalignment where only a sealring alone is used. Because of this, the likelihood of successful creation of a functioning clamp connector can be substantially increased by use of the ring and flange, which reduces the likelihood that a leak would occur. Because of the use of the flow detection system in combination with the ring, the ability to detect a leak at a specific clamp connector can also be substantially increased. Finally, because the implementations of flow detection systems disclosed herein have the ability to meter the flow of leaking gas to that which can be carried by the flow opening of the ring, the amount of leaking gas can be correspondingly limited, which can reduce the release of gas which could lead to a hazardous situation during operation of a clamp connector until the system can be taken down to address the leak.

Referring to FIG. 16, a cross sectional exploded view of an implementation of a ring 114 adjacent to a sealring implementation 116 and hub implementation 118 is illustrated. This ring implementation contains a similar flange 120 to those disclosed herein that similarly includes o-rings 122, 124 installed in seal channels 126, 128 on each side of the flange 120. In this ring implementation 114 however, the flange 120 is not centered inside the ring, but offset so that there is space for an additional gripping channel 130 to be formed in the circumference of the ring into which an additional o-ring 132 is placed. As illustrated in FIG. 16, during assembly of the clamp connector, after placement of the sealring 116 against the hub 118, the ring 114 is inserted over the circumference of the hub 118 allowing the o-ring 132 in the gripping channel 120 to contact the outer curved surface of the hub 118. This allows the mechanical alignment of the ring 114 to be held in position relative to the hub 118 while the second hub of the clamp connector (not shown in FIG. 16) is placed into the ring against the o-ring 126 and the clamp is placed around the ring and two hubs and tightened. In this way, the gripping channel 130 and o-ring 132 work to reduce the number of mechanical degrees of freedom the two hubs and ring have during the assembly and further assist with ensuring that parallel sealing surfaces to the sealring are presented by both hubs, further reducing the likelihood of a leak occurring.

In the implementation of FIG. 16, a projection 134 is present in which flow opening 136 is included which may be any flow opening disclosed in this document coupled to any extender, indicator, and cap implementation disclosed herein. In this way, the ring 114 both helps with assembly to minimize leaks and also works to detect leaks during crank and during operation. While the use of a gripping channel 130 on just one side of the ring 114 is illustrated in FIG. 16, in other implementations, the width of the ring may be made wide enough to accommodate a second gripping channel and corresponding o-ring that is designed to receive the second hub and hold it in position while the clamp is applied and tightened. In such an implementation, the flange 120 would be centered inside the ring like the other ring implementations disclosed here.

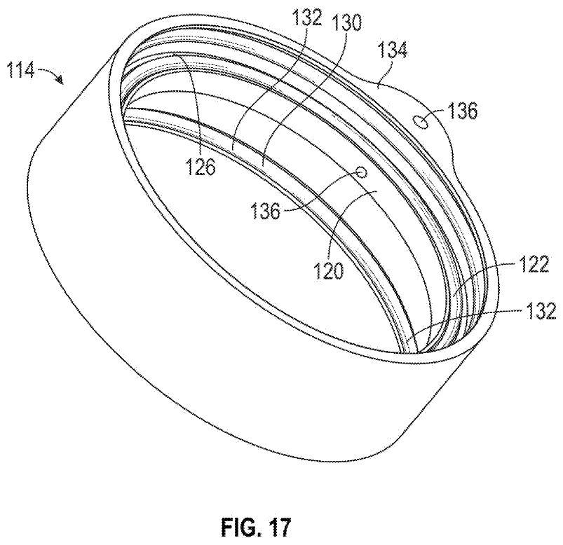

Referring to FIG. 17, an implementation of the ring 114 is illustrated in a perspective view showing the position of the flange 120, flow opening 136, and gripping channel 130 with o-ring 132 installed therein. Also illustrated is o-ring 122 and in seal channel 126 along with projection 134. In this view the ability of the ring 114 to help grab/grip/hold the hub during installation is illustrated.

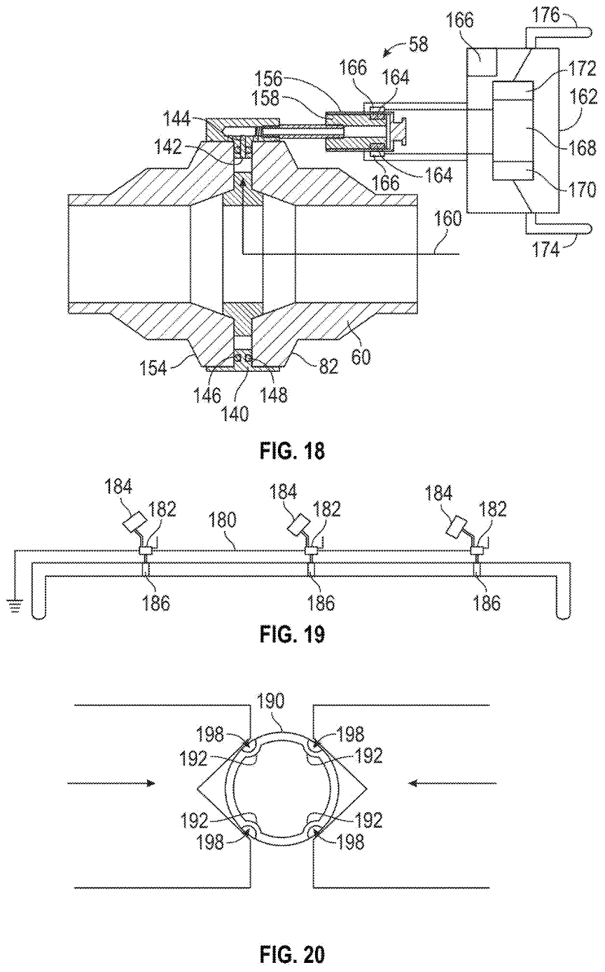

Referring to FIG. 18, another implementation of an indicator system of a gas leak indication/detection system 138 is illustrated. As illustrated in this implementation, the structure of the corresponding ring 140; o-rings 146, 148; flange 142; flow channel 144; and clamp connector 150 with corresponding hubs 152, 154 may be structured like any implementation previously described in this document. In this implementation a cap 156 is coupled over the indicator 158 and is arranged to be slidable relative to the indicator 158 so that when leaking gas 160 from between the hubs 152, 154 enters the flow channel 144, the cap 156 moves under the resulting pressure force a certain distance.

As illustrated in FIG. 18, attached or otherwise coupled to the cap 156 is a sensor system 162. In some implementations, the sensor system 162 may be coupled only to the cap 156; in other implementations, the sensor system 162 may be coupled in part to the cap 146; in yet other implementations, the sensor system 162 may be coupled only to the indicator 158. In each of these implementations, the cap 156 is slidable to the indicator 158. One or more permanent magnets 164 is included in the structure of the cap 156 and/or indicator 158. In some implementations, like the version illustrated in FIG. 18, the permanent magnets 164 are coupled directly to/incorporated in the indicator 158. In other implementations, the permanent magnets 164 are directly coupled to the cap/incorporated in the cap 156. One or more magnetic sensors 166 are included on the cap 156 or in the sensor system 162 which are designed to detect movement of the cap 156 by detecting movement of the one or more magnetic sensors 166 relative to the one or more permanent magnets 164 (or vice versa). These may be Hall sensors in some implementations or any other magnetic sensor type.

In response to detecting movement through sensing a change in magnetic field or movement of magnetic field, the one or more magnetic sensors 166 send a corresponding electrical signal to a controller 168 that is included in the sensor system 162. The controller 168 is then designed to prepare a data transmission/one or more data packets that corresponds with the electrical signal received and then send the data transmission to a communication wire (not shown in FIG. 18) or to one or more radios 170, 172. The one or more radios 170, 172 are coupled to antennas 174, 176 which are sized/dimensioned/configured to emit and receive radio frequency electromagnetic signals that transmit the data transmission to a gas leak monitoring system. A wide variety of radio system types may be utilized in various implementations including, by non-limiting example, any of IEEE 802.11b/a/g/n/ac/ax/be, ZIGBEE®, BLUETOOTH®, 900 MHz, 2.4 GHz, 5.8 GHz, DECT 6.0, 1.9 GHz, commercial cellular signals (2G, 3G, 4G, 5G, 6G, etc.), satellite telecommunication protocols, or any other wireless telecommunication protocol. The radio transmission may be just a one time transmission or may be a continuous transmission or a periodic transmission that occurs at a desired time internal. The gas leak monitoring system may be a component of a larger plant control/monitoring system, may be a standalone system, or may be partially integrated with a main plant control/monitoring system.

When the data transmission is received via the one or more radios 170, 172 at the gas leak monitoring system, a corresponding alarm/alert is created which informs the operator(s) of the presence of a gas leak in the clamp connector 150 and identifying the location/number of the clamp connector 150 that is leaking. In some implementations, the sensor system 162 may be able to provide an estimate of the degree of the leak/flow rate of the leaking gas by the controller calculating the travel of the cap 156, the force needed to produce the travel, and using the gas density and operating temperature to calculate a corresponding gas flow. The ability for the operators to be able to be notified in substantially real time of a leaking clamp connector fitting allows the operators to take appropriate action through assessing the degree of the leak, scheduling downtime, or making an emergency shutdown of the corresponding equipment to prevent the leak from creating a dangerous system/environmental condition.

As illustrated in FIG. 18, a power supply 178 is included in the sensor system 162. The power supply 178 may be, by non-limiting example, a coin cell battery, an alkaline battery, a rechargeable battery, a lithium ion battery, a combination of a solar power device and a battery, a power supply attached to a power main/power supply line, or any other appropriately dimensioned power source designed to power the components of the sensor system 162.

The sensor system 162 illustrated in FIG. 18 may be utilized in an industrial plant where high pressure gas lines are used to supply gas to various plant components and where the clamp connectors are located inside buildings and/or outside buildings but within a certain distance of the gas leak monitoring system so that none of the sensor systems are outside of a range of the one or more radios. In some implementations, wireless repeaters, amplifiers, or range extenders may be utilized to extend the operating range of the various sensor systems to cover a larger geographic area. However, in some use conditions, particularly where the sensor systems are employed to monitor clamp connectors in gas lines that are remote geographically from a monitoring location as in a long distance natural gas pipeline system, the use of individual wireless sensors may not be practical. Referring to FIG. 19, as other control components (valves, pressure sensors, weather sensors, etc.) may already include signal wiring designed for remote control/monitoring of these components at their geographic location along the pipeline, the sensor system component of each indicator system may be electrically connected to a communication wire 180. The communication wire 180 may be only a signal carrying wire or a combination of a power carrying wire and signal carrying wire. As illustrated in FIG. 19, a plurality of indicator systems 182 are coupled with the communication wire 180. In the implementation illustrated in FIG. 19, the communication wire 180 carries only signal as each indicator system 182 is equipped with a solar panel 184 that collects power and stores it in an internal battery which acts as a power source for each of the indicator systems 182. In other implementations, the communication wire 180 may also include a power connection to a battery at the particular geographic location or a power source connected to a main line that powers the equipment at the particular geographic location.

In FIG. 19, the various indicator systems 182 are illustrated to also include radio components and corresponding antennas, and thus, if the communication wire carries power, the indicator systems 182 may communicate with a base station at the geographic location which is then the only component in the system that is connected to the signal portion of communication wire. This allows the indicator systems 182 to not have to connect to the signal portion and just use the power portion of the wire. As illustrated, each of the indicator systems 182 are coupled to a corresponding clamp connector 186 of a plurality of clamp connectors that is located a particular location along pipeline 188. Because the clamp connectors 186 may typically be located in the open air, the ability for a manual inspection of the clamp connectors 186 for leaks may be very difficult to accurately perform. The use of the indicator systems (which may be any indicator system disclosed herein that includes any implementation of sensor system disclosed herein) allows for automatic detection of and communication to a remote operator of the existence of a leak in a specific clamp connector. This ability to specifically identify the leaking clamp connector can allow for timely remediation and significantly reduce gas emissions which can have a meaningful impact on greenhouse gas emissions from the pipeline caused by leaking clamp connectors. In various system implementations, the communication wire 180 is coupled to a gas leak monitor system like any previously described.

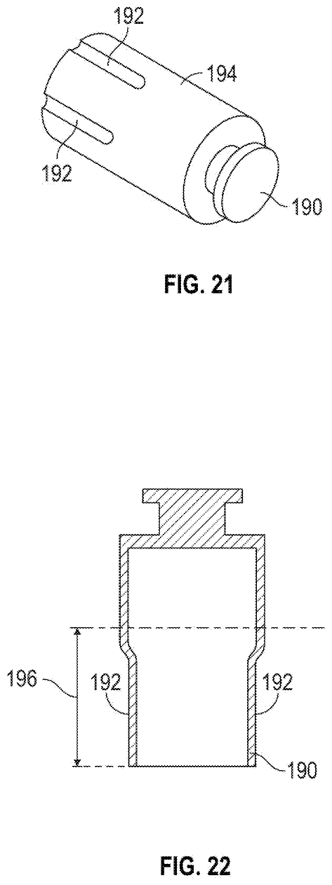

Referring to FIG. 21, an implementation of a cap 190 is illustrated that does not include a groove or o-ring structure on the interior of the cap designed to retain the cap 190 over an indicator until a predetermined leaking gas pressure is reached like the implementations previously described. Instead, one or more crimped portions 192 in the outer surface 194 of the cap 190 are included that precisely narrow the dimensions of a lower portion 196 of the cap 190 (see FIG. 22). The precise narrowing of the lower portion 196 through the one or more crimped portions 192 causes the lower portion 196 to engage more closely with the indicator and increase the degree of friction to a similar degree as was achieved with the grooved cap implementations previously described or if an o-ring is fitted into the interior surface of the cap or exterior surface of the indicator. However, unlike the o-ring solution where the o-ring eventually breaks down under high temperature conditions or unlike the groove solution where consistent precise machining tolerance is needed during machining of the cap and indicator to ensure the desired release force is reached, the use of crimping can improve process uniformity.

As illustrated in FIG. 20, the cap 190 is illustrated during forming of the crimped portions 192. As illustrated, a vise/press is used that has two halves with die portions that have contact portions 198 indicated by the arrows that are precisely sized and positioned in the vise/press so that when the two portions are brought together at a desired pressure, the crimped portions 192 are formed in the material of the cap 190. The crimped portions 192 thus narrow the lower portion to a desired circumference. Because of the degree of precision used to form the contact portions 198 and the repeatability of the pressure that can be applied using the vise/press to the cap, the circumference created using the crimped portions 198 can be repeatably created even using caps machined to different tolerances. In this way, manufacturing variations in the cap can be handled and help ensure that repeatable friction force between the indicator and the cap can be achieved for every cap/indicator combination. In this way, detection of gas leaks at a desired level of pressure repeatably across a wide number of gas leak detection systems can be achieved despite normal manufacturing process variations.

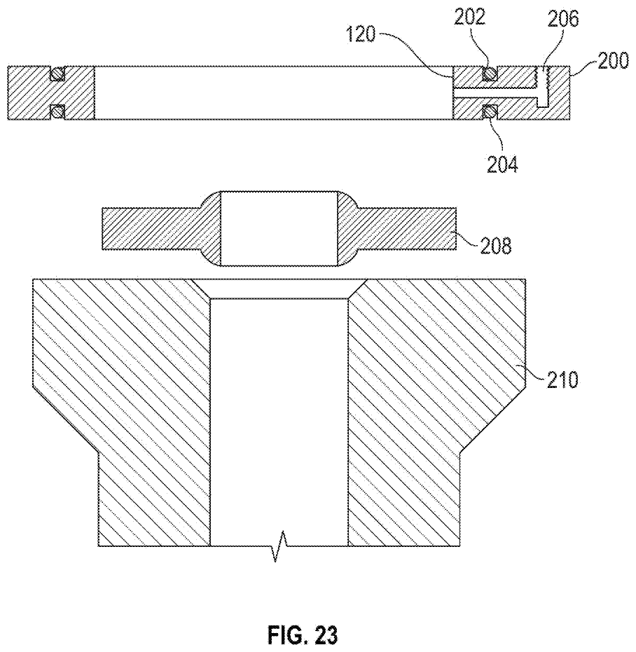

The various ring implementations disclosed in this document, like those illustrated in FIG. 16, have included rings 114 with extensions/flanges on each side of the central portion in which seal channels 126, 128 are formed. These extensions/flanges are sized to extend along a face/surface of the hub 118 of the clamp connector. However, referring to FIG. 23, a ring implementation 200 is illustrated that does not have extensions/flanges and where the surface in which the seal channels 202, 204 extends flush to the edge of the ring. While the material of the ring into which the indicator engages at the threaded opening 206 is thinner, it is sufficient to retain the indicator therein. Because the operation of the ring is to capture gas leaking into the interior space of the ring created from the sealring 208 of the clamp connector during operation, having no extensions/flanges is not needed for the ring to successfully direct gas flow to the threaded opening 206 and to the indicator. While the ring 200 may provide less mechanical stability to the clamp connector during and after installation between the hubs 210 due to the lack of the extensions/flanges, it may still function satisfactorily with respect to gas leak detection using any indicator system disclosed herein.

In the various system implementations disclosed herein, the ring portion of the system has been illustrated (see FIG. 16) as including seal channels 126, 128 into which o-rings are placed. One of the disadvantages of o-rings is that over time and under high temperature conditions, the material of the o-rings can degrade, increasing the potential for gas leaking from the sealring to leak from the area inside the ring and not exit through the flow channel to the indicator allowing the leak to be detected. These o-rings become a consumable material that requires disassembly of the clamp connector to replace which is generally undesirable. Also, the need to machine the seal channels into the material of the ring limits the diameter of the flow channel that that can be included in the ring to guide leaking gas to the indicator. A larger flow channel is easier to machine or form, and so the ability to not lose ring material to the seal channels would be helpful.

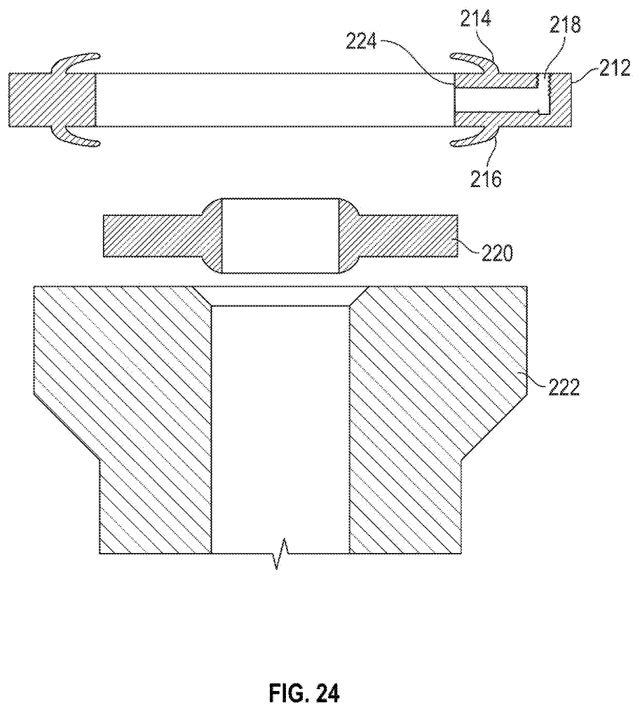

Referring to FIG. 24, an implementation of a ring 212 is included that is not made of metal or machined but is made of a polymer material or resin material. Because the ring 212 is formed using plastic forming process such as, by non-limiting example, injection molding, 3D printing, casting, or other methods of shaping plastics, the structure of the ring can be changed to not utilize o-rings. As illustrated in FIG. 24, the ring 212 includes projections 214, 216 on each side of the ring which are designed to resiliently engage with the interior face of hub 222 and form a gas-tight seal around sealring 220. The gas tight seal ensures that any gas that leaks from the sealring 220 is directed to flow channel 224. Comparing the size of the flow channel of FIG. 24 to that of FIG. 16 indicates that the absence of the seal channels 126, 128 has allowed the flow channel 224 to have a larger diameter than the corresponding structure in FIG. 16. The projections 214, 216 are illustrated as having the appearance of fins in cross section but could have other shapes including triangular, rectangular, ovoid, or another shape that allows them to be resiliently compressed and not plastically crushed as the clamp connector is installed and the hubs are tightened down. As with the other versions of rings disclosed herein, the gas that enters the flow channel 224 is then directed to flow opening 218 into which and extender and/or indicator are threadedly coupled. Any of the indicator types and associated sensor systems may be utilized with the ring 212 design illustrated in FIG. 24.

A wide variety of plastic material types including various polymers and resins that have sufficient or desired thermal stability and/or resiliency may be utilized in various ring implementations. Also, a wide variety of projection types may be constructed using the principles disclosed in this document.

In places where the description above refers to particular implementations of gas leak indication systems and implementing components, sub-components, methods and sub-methods, it should be readily apparent that a number of modifications may be made without departing from the spirit thereof and that these implementations, implementing components, sub-components, methods and sub-methods may be applied to other gas leak indication systems.

What is claimed is:

1. An indicator system for a gas leak indication system comprising:
a cap coupled over an indicator coupled to a ring configured to rest against exterior surfaces of a clamp connector, the cap comprising:
a magnetic sensor in magnetic communication with a permanent magnet coupled to the indicator;
a controller coupled to the magnetic sensor and configured to process a signal from the magnetic sensor, prepare a corresponding data transmission, and send the data transmission to one of a communication wire or one or more radios operably coupled with the controller; and
a power supply operatively coupled with the controller and the magnetic sensor;
a ring comprising a flange extending from an interior surface of the ring, the ring comprising a flow opening, and the ring configured to rest against exterior surfaces of a clamp connector; and
an indicator coupled to the ring, the indicator comprising a flow channel extending therethrough in fluid communication with the flow opening of the ring.

2. The system of claim 1, further comprising an antenna coupled to the one or more radios.

3. The system of claim 1, wherein the ring comprises a flange configured to rest between two hubs of the clamp connector adjacent to a sealring held between the two hubs and the ring is configured to be held against the exterior surfaces of the two hubs through a clamp coupled with the two hubs.

4. The system of claim 2, wherein the one or more radios transmit the data transmission to a gas leak monitoring system.

5. The system of claim 1, further comprising a solar energy collector operably coupled with the power supply.

6. The system of claim 1, wherein the power supply further comprises a battery.

7. The system of claim 1, wherein when a predetermined flow of gas passes through the flow opening of the ring into the flow channel of the indicator, the cap is configured to activate the magnetic sensor.

8. The system of claim 7, wherein the magnetic sensor is coupled directly to the cap and the permanent magnet is coupled directly to the indicator.

9. The system of claim 7, wherein the magnetic sensor is coupled directly to the indicator and the permanent magnet is coupled directly to the cap.

10. A gas leak indication system comprising:
a plurality of indicator systems coupled with a communication wire, a ring comprised in each indicator system of the plurality of indicator systems, the ring configured to be coupled between two hubs of a clamp connector of a plurality of clamp connectors comprised in a gas pipeline;
wherein the communication wire is operably coupled with a gas leak monitoring system.

11. The gas leak indication system of claim 10, wherein each indicator system of the plurality of indicator systems comprises a cap coupled over an indicator, a magnetic sensor magnetically coupled with a permanent magnet coupled to the indicator, and a controller operably coupled with the magnetic sensor and with the communication wire where the controller is further configured to process a signal from the magnetic sensor, prepare a corresponding data transmission, and send the data transmission to the a communication wire.

12. The gas leak indication system of claim 11, wherein the ring of each indicator system of the plurality of indicator systems comprises a flange extending from an interior surface of the ring, the flange configured to extend between two hubs of a clamp connector, the ring comprising a flow opening therein and the ring configured to contact exterior surfaces of the hubs of the clamp connector and wherein the cap is in fluid communication with the flow opening.

13. The gas leak indication system of claim 11, wherein when a predetermined flow of gas passes through a flow opening of the ring into a flow channel of the indicator, the cap is configured to activate the magnetic sensor.

14. The gas leak indication system of claim 13, wherein the magnetic sensor is coupled directly to the cap and the permanent magnet is coupled directly to the indicator.

15. The gas leak indication system of claim 13, wherein the magnetic sensor is coupled directly to the indicator and the permanent magnet is coupled directly to the cap.

16. The gas leak indication system of claim 11 wherein the communication wire is configured to supply electric power to the controller and the magnetic sensor.

17. A gas leak indication system comprising:
a ring comprising a flange extending from an interior surface of the ring, the ring comprising a flow opening, the ring comprising a plurality of projections extending from a surface of the ring configured to engage with interior surfaces of hubs of a clamp connector;
an indicator coupled to the ring, the indicator configured to continuously monitor for a leak from the clamp connector while gas flows through the clamp connector,
wherein the indicator is coupled into the flow opening, where the flow opening is configured to orient the indicator substantially perpendicular to the clamp connector.

18. The system of claim 17, wherein when a predetermined flow of gas passes through the flow opening of the ring into a flow channel of the indicator, a cap of the indicator is configured to slidably disengage from the flow opening of the ring.

19. The system of claim 17, wherein the plurality of projections resiliently engage with the interior surfaces of the hubs to form a gas-tight seal around a sealring of the clamp connector.

20. The system of claim 17, wherein the ring is comprised of one of a polymer material or a resin material.
